(19) United States
(12) Patent Application Publication
(10) Pub. No.: US 2024/0217852 A1
(43) Pub. Date: Jul. 4, 2024

(54) BIOLOGICAL WASTEWATER PROCESSING SYSTEM AND METHOD FOR PROCESSING THE SAME

(71) Applicant: INDUSTRIAL TECHNOLOGY RESEARCH INSTITUTE, Hsinchu (TW)

(72) Inventors: Laurensia IRMAYANI, Hsinchu City (TW); Wun-Jie HUANG, Taoyuan City (TW); Hsin-Ju HSIEH, Hsinchu City (TW); Jia-Jun TEE, Tainan City (TW); Shing-Der CHEN, Chiayi City (TW); Ren-Yang HORNG, Zhubei City (TW); Jer-Young CHEN, Hsinchu City (TW)

(73) Assignee: INDUSTRIAL TECHNOLOGY RESEARCH INSTITUTE, Hsinchu (TW)

(21) Appl. No.: 18/147,954

(22) Filed: Dec. 29, 2022

(51) Int. Cl. C02F 3/34; C02F 9/20

(52) U.S. Cl. CPC C02F 3/347; C02F 3/345; C02F 9/20; C02F 2101/30

(57) ABSTRACT

A biological wastewater processing system is provided, which includes a processing unit and a desulfurization bacteria culture tank. The processing unit is used to remove humic acid or color from wastewater. The processing unit includes a plurality of porous carriers, and the desulfurization bacteria and white-rot fungi are immobilized on the porous carriers. The desulfurization bacteria culture tank is used for cultivating the desulfurization bacteria, and the desulfurization bacteria culture tank is connected to the processing unit. In addition, the desulfurization bacteria culture tank produces a liquid containing sulfate ions, and the liquid containing sulfate ions is introduced into the processing unit to control the pH value of the processing unit, so that the pH value of the processing unit is between 5.5 and 6.5. A method for processing biological wastewater is also provided.

### TECHNICAL FIELD

The present disclosure is related to a biological wastewater processing system and a method for processing the same, and in particular it is related to a biological wastewater processing system combined with the compound growth of desulfurization bacteria and white-rot fungi and a processing method thereof.

### BACKGROUND

Biological wastewater (for example, livestock husbandry wastewater, agricultural wastewater etc.) usually contains a high concentration of organic matter, which causes the chemical oxygen demand (COD) to be too high to meet the discharge standards for wastewater. Therefore, biological wastewater generally needs to be processed using appropriate procedures before discharge. The main organic components of biological wastewater include humic substances (humic acid and fulvic acid).

In recent years, the domestic livestock husbandry industry has begun to adopt membrane procedures (for example, technologies such as membrane bioreactor (MBR) filtration, ultrafiltration/reverse osmosis (UF/RO)) to recycle wastewater. However, humic substances tend to be deposited on the surface of the membrane, causing membrane fouling and resulting in poor processing efficiency and increased operating costs.

In view of the foregoing, although the existing biological wastewater processing technologies can substantially meet their originally intended purposes, they still do not fully meet the requirement in all respects. The development of a biological wastewater processing system with high efficiency, high stability and reduced cost is still one of the current research topics in the industry.

### SUMMARY

According to embodiments of the disclosure, a biological wastewater processing system is provided, including a processing unit and a desulfurization bacteria culture tank. The processing unit is used for removing humic acid or color of the wastewater. The processing unit includes a plurality of porous carriers, and desulfurization bacteria and white-rot fungi are immobilized on the plurality of porous carriers. The desulfurization bacteria culture tank is used for cultivating desulfurization bacteria, and the desulfurization bacteria culture tank is connected to the processing unit. In addition, the desulfurization bacteria culture tank produces a liquid containing sulfate ions, and the liquid containing sulfate ions is introduced into the processing unit to control the pH value in the processing unit, so that the pH value of the processing unit is between 5.5 and 6.5.

According to embodiments of the disclosure, a method for processing biological wastewater is provided, including providing the aforementioned biological wastewater processing system. The biological wastewater processing system includes a processing unit and a desulfurization bacteria culture tank. The processing unit is used for removing humic acid or color of the wastewater. The processing unit includes a plurality of porous carriers, and desulfurization bacteria and white-rot fungi are immobilized on the plurality of porous carriers. The desulfurization bacteria culture tank is used for cultivating desulfurization bacteria, and the desulfurization bacteria culture tank is connected to the processing unit. In addition, the desulfurization bacteria culture tank produces a liquid containing sulfate ions, and the liquid containing sulfate ions is introduced into the processing unit to control the pH value in the processing unit, so that the pH value of the processing unit is between 5.5 and 6.5. Moreover, the method for processing biological wastewater further includes introducing a wastewater containing humic acid or color into the biological wastewater processing system and exporting the processed wastewater out of the processing unit.

A detailed description is given in the following embodiments with reference to the accompanying drawings.

### BRIEF DESCRIPTION OF THE DRAWINGS

FIG. 1 is a schematic diagram of a biological wastewater processing system in accordance with an embodiment of the present disclosure.

FIG. 2 is the wastewater processing results obtained by using the biological wastewater processing system shown in FIG. 1 in accordance with an embodiment of the present disclosure.

FIG. 3 is the wastewater processing results obtained by using a continuous reaction tank with activated sludge as microbial source.

FIG. 4 is the wastewater processing results obtained by using a continuous reaction tank with white-rot fungi as microbial source.

### DETAILED DESCRIPTION

The biological wastewater processing system and the method for processing the biological wastewater of the present disclosure are described in detail in the following description. It should be understood that in the following detailed description, for purposes of explanation, numerous specific details and embodiments are set forth in order to provide a thorough understanding of the present disclosure. The elements and configurations described in the following detailed description are set forth in order to clearly describe the present disclosure. These embodiments are used merely for the purpose of illustration, and the present disclosure is not limited thereto. In addition, different embodiments may use like and/or corresponding numerals to denote like and/or corresponding elements in order to clearly describe the present disclosure. However, the use of like and/or corresponding numerals of different embodiments does not suggest any correlation between different embodiments.

The present disclosure can be understood by referring to the following detailed description in connection with the accompanying drawings. It should be understood that the drawings of the present disclosure may be not drawn to scale. In fact, the size of the elements may be arbitrarily enlarged or reduced to clearly show the features of the present disclosure.

In addition, in the embodiments, relative expressions may be used. For example, “lower”, “bottom”, “higher” or “top” are used to describe the position of one element relative to another. It should be appreciated that if a device is flipped upside down, an element that is “lower” will become an element that is “higher”.

It should be understood that, although the terms “first”, “second”, “third” etc. may be used herein to describe various elements, layers, regions, or portions, these elements, layers, regions, or portions should not be limited by these terms. These terms are only used to distinguish one element, layer, region, or portion from another element, layer, region, or portion. Thus, a first element, layer, region, or portion discussed below could be termed a second element, layer, region, or portion without departing from the teachings of the present disclosure.

Moreover, in accordance with the embodiments of the present disclosure, regarding the terms such as “connected”, “interconnected”, etc. referring to bonding and connection, unless specifically defined, these terms mean that two structures are in direct contact, or two structures are not in direct contact and other structures are provided to be disposed between the two structures.

In the context, the terms “about” and “substantially” typically mean+/−10% of the stated value, or typically +/−5% of the stated value, or typically +/−3% of the stated value, or typically +/−2% of the stated value, or typically +/−1% of the stated value or typically +/−0.5% of the stated value. The stated value of the present disclosure is an approximate value. When there is no specific description, the stated value includes the meaning of “about” or “substantially”. In addition, the term “in a range from the first value to the second value” or “between the first value and the second value” means that the range includes the first value, the second value, and other values in between.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

Embodiments of the present disclosure provide a biological wastewater processing system, including a processing unit combined with the compound growth of desulfurization bacteria and white-rot fungi and a desulfurization bacteria culture tank. The biological wastewater processing system can cultivate a large amount of dominant desulfurization bacteria and white-rot fungi, stably remove humic acid and color in wastewater, reduce chemical oxygen demand (COD), and improve the efficiency of biological wastewater processing. In addition, the liquid produced by desulfurization reaction carried out in the desulfurization bacteria culture tank can be directly used to adjust the pH value of the processing unit, without adding additional reagents (such as sulfuric acid) for acid-base control, which can reduce operating costs.

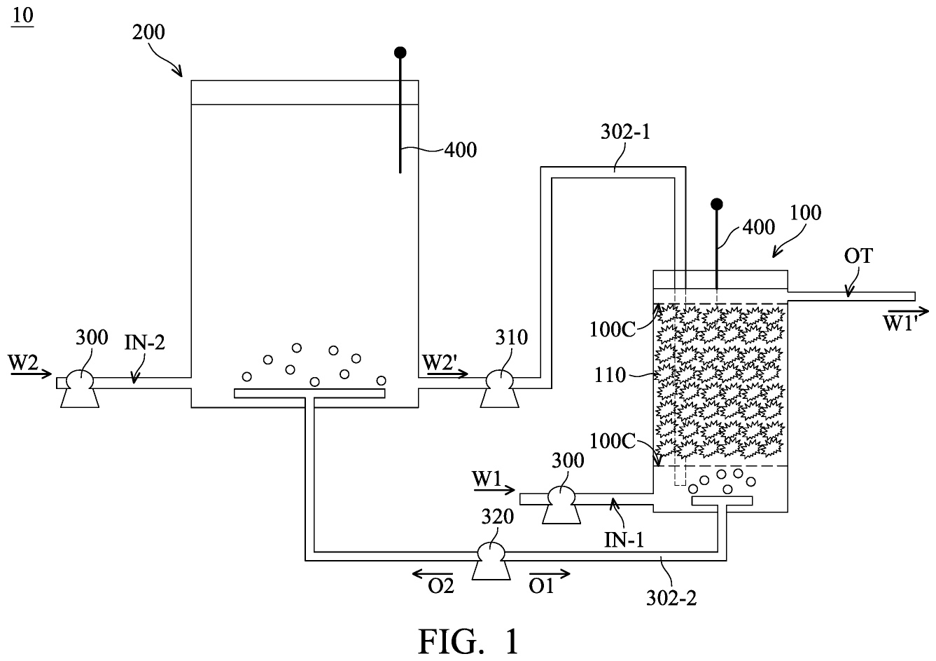

FIG. 1 is a schematic diagram of a biological wastewater processing system 10 in accordance with an embodiment of the present disclosure. It should be understood that, for the sake of clarity, some elements of the biological wastewater processing system 10 are omitted in the figure, and only some elements are schematically shown. In accordance with one embodiment, additional features may be added to the biological wastewater processing system 10 described below.

Please refer to FIG. 1, biological wastewater processing system 10 includes a processing unit 100 and a desulfurization bacteria culture tank 200. The processing unit 100 is used for removing humic acid or color of the wastewater, and the desulfurization bacteria culture tank 200 is used for cultivating desulfurization bacteria. The desulfurization bacteria culture tank 200 is connected to the processing unit 100. Specifically, in accordance with one embodiment, the desulfurization bacteria culture tank 200 may be connected to the processing unit 100 through a connection part 302-1. For example, the bottom of the desulfurization bacteria culture tank 200 may be connected to the top of the processing unit 100 through the connection part 302-1. Furthermore, the processing unit 100 and the desulfurization bacteria culture tank 200 may be connected in series.

In accordance with another embodiment, the biological wastewater processing system 10 may include a plurality of processing units 100 and a plurality of desulfurization bacteria culture tanks 200, to process a larger amount of gas. In addition, a plurality of processing units 100 and a plurality of desulfurization bacteria culture tanks 200 may be connected in the aforementioned manner.

The processing unit 100 includes a plurality of porous carriers 110, and desulfurization bacteria and white-rot fungi are fix immobilized on the porous carriers 110. Specifically, white-rot fungi may be directly added to the processing unit 100, and the desulfurization bacteria cultured in the desulfurization bacteria culture tank 200 may be transported to the processing unit 100 through the connection part 302-1, and immobilized on the porous carriers 110. In accordance with some embodiments, the ratio (by dry weight, w/w) of desulfurization bacteria to white-rot fungi may be between 1:15 and 1:5. For example, the ratio of desulfurization bacteria to white-rot fungi may be about 1:10. When too much desulfurization bacteria enters the processing unit 100, it will accumulate on the porous carriers 110 and clogging them. This may result in problems such as the need for excessive frequent backwashing and so on.

The processing unit 100 may further include a partition plate 100C. The partition plate 100C may be disposed in the tank of the processing unit 100, and the porous carriers 110 may be disposed in the space formed by the partition plate 100C. In accordance with some embodiments, the tank of the processing unit 100 may have two layers of partition plates 100C, which are respectively disposed on the upper and lower parts of the processing unit 100. The porous carriers 110 are disposed between the two layers of partition plates 100C, in order to prevent the porous carriers 110 from being lost along with the flowing water, and to avoid the compaction of the carriers. Furthermore, the partition plate 100C has a plurality of holes (not shown), so that the liquid can circulate in the processing unit 100. The size of the hole is smaller than the size of the porous carrier 110, thereby preventing the porous carriers 110 from clogging the holes and interfering with the circulation and processing performance of the liquid in the processing unit 100.

In accordance with an embodiment, the tank material of the processing unit 100 and the desulfurization bacteria culture tank 200 may include for example, polypropylene, polyethylene, or other suitable corrosion-resistant materials.

In accordance with an embodiment, the porous carrier 110 has a pore size between 200 micrometers (μm) and 2000 μm, or between 1500 μm and 2000 μm. In accordance with some embodiments, the specific surface area of the porous carrier 110 may be between 800 square meters/cubic meters (m²/m³) and 8000 m²/m³, or between 800 m²/m³ and 4000 m²/m³. In accordance with some embodiments, the filling rate of the porous carriers 110 in the processing unit 100 may be between 60% and 90%, or between 60% and 80%.

In accordance with some embodiments, the material of the porous carrier 110 may include polyurethane (PU), porous foam, polyvinyl alcohol (PVA), polyethylene (PE) or a combination thereof, but not limited thereto.

It is worth noting that the aforementioned porous carrier 110 with high specific surface area, high porosity, and high permeability can provide a favorable attachment and growth environment for white-rot fungi and desulfurization bacteria, and can effectively improve the COD removal rate of wastewater.

As shown in FIG. 1, the biological wastewater processing system 10 may further include a first inlet IN-1 for introducing a wastewater W1 containing humic acid or color into the processing unit 100. The first inlet IN-1 may be disposed at the bottom of the processing unit 100. In accordance with some embodiments, the wastewater W1 containing humic acid or color may include livestock husbandry wastewater, agricultural wastewater, wastewater from biomass energy plants, industrial wastewater, or a combination thereof, but is not limited thereto. Furthermore, the processing unit 100 may further include an outlet OT for exporting the processed wastewater W1′ out of the processing unit 100. The outlet OT may be disposed at the top of the processing unit 100. Specifically, in accordance with some embodiments, the wastewater W1 containing humic acid or color may enter the processing unit 100 from the first inlet IN-1 to react with white-rot fungi and desulfurization bacteria, and the processed wastewater W1′ may then leave the processing unit 100 through the outlet OT. In addition, in accordance with some embodiments, the first inlet IN-1 may have a motor 300, and the motor 300 may introduce the wastewater W1 containing humic acid or color into the processing unit 100, and may control the flow rate and the like.

White-rot fungi can oxidize aromatic compounds such as lignin peroxidase, manganese peroxidase, or laccase, and cleave the benzene ring to degrade humic acid and color in wastewater. In accordance with some embodiments, the dominant white-rot fungi in the processing unit 100 may include Burkholderiaceae, Coprococcus, Leucobacter, Corynebacterium, Clostridium, Pseudomonas, Panaerochaete chrysosporium, or other suitable species of white-rot fungi, but are not limited thereto.

Furthermore, the biological wastewater processing system 10 may further include a second inlet IN-2 for introducing sulfur-containing wastewater into the desulfurization bacteria culture tank 200. The second inlet IN-2 may be disposed at the bottom of the desulfurization bacteria culture tank 200. Specifically, in accordance with some embodiments, a wastewater W2 containing sulfur may enter the desulfurization bacteria culture tank 200 from the second inlet IN-2 to react with the desulfurization bacteria, and the processed wastewater W2′ may then transported to the processing unit 100 through the connection part 302-1. In accordance with some embodiments, the wastewater W2 containing sulfur may include livestock husbandry wastewater, agricultural wastewater, wastewater from biomass energy plants, industrial wastewater, or a combination thereof, but is not limited thereto. In addition, in accordance with some embodiments, there may be a motor 300 at the second inlet IN-2, and the motor 300 may introduce the wastewater W2 containing sulfur into the desulfurization bacteria culture tank 200, and may control the flow rate and the like. In accordance with some embodiments, the connection part 302-1 may be connected to a circulation motor 310, and the circulation motor 310 may be disposed in the connection part 302-1. The circulation motor 310 may provide power to make the liquid flow between the desulfurization bacteria culture tank 200 and the processing unit 100. For example, the processed wastewater W2′ in the desulfurization bacteria culture tank 200 may be introduced into the processing unit 100.

Specifically, after the wastewater W2 containing sulfur enters the desulfurization bacteria culture tank 200, it will act with the desulfurization bacteria to oxidize the reduced sulfur ion (S²⁻) into elemental sulfur (S⁰) and sulfate ion (SO₄²⁻), so that the wastewater W2 containing sulfur can undergo a desulfurization reaction. The high-concentration sulfuric acid waste liquid produced by the reaction can be used as an acid liquid for adjusting the pH value of the processing unit 100 to reduce operating costs and provide a suitable growth environment for white rot fungi. In accordance with some embodiments, the pH value of the desulfurization bacteria culture tank 200 may be between 1 and 4, for example, pH2 or pH3.

Desulfurization bacteria may be autotrophic desulfurization bacteria. In accordance with some embodiments, the dominant desulfurization bacteria in the processing unit 100 and the desulfurization bacteria culture tank 200 may include Acidithiobacillus, Clostridium, Mycobacterium, Pseudomonas, Sulfobacillus or other suitable species of desulfurization bacteria, but are not limited thereto.

It should be noted that, because the growth rate of white-rot fungi is relatively slow, suitable pH conditions are needed for growth. As mentioned above, the desulfurization bacterial culture tank 200 produces liquid containing sulfate ions, which is introduced to the processing unit 100 to keep the pH value of the processing unit 100 between 5.5 and 6.5. The pH range of 5.5 to 6.5 is in line with the conditions suitable for the growth of white-rot fungi. In accordance with the embodiments of the present disclosure, using the processing unit 100 combined with the compound growth of desulfurization bacteria and white-rot fungi and the desulfurization bacteria culture tank 200, a large amount of dominant desulfurization bacteria and white-rot fungi can be cultivated (for example, the dominant bacteria group that can removal humic acid is increased by about 10 times), stably remove humic acid and color in wastewater and reduce chemical oxygen demand (COD), and improve the efficiency of biological wastewater processing. In addition, the acid produced by the desulfurization reaction in the desulfurization bacteria culture tank 200 can be directly used to adjust the pH value of the processing unit 100 without adding additional reagents (such as sulfuric acid) for acid-base control, which can reduce operating costs.

In addition, as shown in FIG. 1, the biological wastewater processing system 10 may further include an aeration device 320, and the aeration device 320 may be connected to the bottom of the processing unit 100 and the bottom of the desulfurization bacteria culture tank 200 through the connection part 302-2. In accordance with some embodiments, the aeration device 320 may be respectively connected to the processing unit 100 and the desulfurization bacteria culture tank 200 through the connection part 302-2. The aeration device 320 may aerate the processing unit 100 and the desulfurization bacteria culture tank 200 according to needs.

Specifically, the desulfurization bacteria culture tank 200 can provide sufficient oxygen for the desulfurization bacteria by means of aeration, and convert the reduced hydrogen sulfide into oxidized sulfate to achieve the goal of high-efficiency desulfurization. Furthermore, the aeration device 320 may be used to backwash the porous carriers 110 in the processing unit 100 to wash away the aging desulfurization bacteria or white-rot fungi accumulated in the processing unit 100.

In accordance with some embodiments, the connection part 302-1 and the connection part 302-2 may include pipelines, and the material of the pipelines may include metals, non-metals or a combination thereof. For example, the aforementioned metals may include stainless steel, copper, aluminum or a combination thereof, but are not limited thereto. The aforementioned non-metals may include silicone, Teflon, rubber or plastic (for example, polyurethane (PU), polypropylene (PP), polyvinyl fluoride (PVC), polyethylene (PE), polymethyl methacrylate (PMMA)) or a combination thereof, but are not limited thereto.

Moreover, the processing unit 100 and the desulfurization bacteria culture tank 200 may further include a pH controller 400, which can be used to monitor the pH of the liquid in the processing unit 100 and the desulfurization bacteria culture tank 200. In accordance with some embodiments, the desulfurization bacteria culture tank 200 may be further configured with redox potential, dissolved oxygen, and conductivity controllers (not shown). The redox potential, dissolved oxygen, and conductivity controllers may be used to monitor the redox potential, dissolved oxygen, conductivity and other water quality parameters of the substances in the processing unit 100 and the desulfurization bacteria culture tank 200. The timing of changing water or adding nutrient matrix can be determined according to the change of water quality parameters such as redox potential, dissolved oxygen, and conductivity.

In addition, the present disclosure also provides a method for processing biological wastewater, including using the aforementioned biological wastewater processing system 10 to perform desulfurization treatment on gas. Hereinafter, the method for processing biological wastewater will be described with the operation of the biological wastewater processing system 10. It should be understood that, according to some embodiments, additional steps may be added before, during and/or after the method for processing biological wastewater described below, or some steps may be replaced or omitted.

As shown in FIG. 1, the wastewater W1 containing humic acid or color may be introduced into the processing unit 100 of biological wastewater processing system 10, so that wastewater W1 containing humic acid or color can be reacted with white-rot fungi and desulfurization bacteria to remove humic acid or color. Specifically, by activating the motor 300, the wastewater W1 containing humic acid or color can enter the processing unit 100 through the first inlet IN-1. In accordance with some embodiments, the wastewater W1 containing humic acid or color may include livestock husbandry wastewater, agricultural wastewater, wastewater from biomass energy plants, industrial wastewater, or a combination thereof, but is not limited thereto. In accordance with some embodiments, the hydraulic retention time (HRT) of the wastewater W1 containing humic acid or color in the processing unit 100 may be between 10 hours and 27 hours, or between 10 hours and 24 hours.

On the other hand, the wastewater W2 containing sulfur may be introduced into the desulfurization bacteria culture tank 200 of the biological wastewater processing system 10, so that the wastewater W2 containing sulfur can be reacted with the desulfurization bacteria. This process oxidizes the reduced sulfur ions (S²⁻) in the wastewater W2 containing sulfur to elemental sulfur (S⁰) and sulfate ions (SO₄²⁻), thereby facilitating the desulfurization reaction of the wastewater W2 containing sulfur. Specifically, by activating the motor 300, the wastewater W2 containing sulfur can enter the desulfurization bacteria culture tank 200 through the second inlet IN-2. In accordance with some embodiments, the wastewater W2 containing sulfur may include livestock husbandry wastewater, agricultural wastewater, wastewater from biomass energy plants, industrial wastewater, or a combination thereof, but is not limited thereto. In accordance with some embodiments, the hydraulic retention time of the wastewater W2 containing sulfur in the processing unit 100 may be between 10 hours and 14 hours, or between 10 hours and 12 hours.

Next, the processed wastewater W2′ may be transported to the processing unit 100 through the connection part 302-1. The processed wastewater W2′ has a high concentration of sulfate ions (SO₄²⁻), which can be used as an acid solution to adjust the pH value of the processing unit 100. In other words, the pH value of the processing unit 100 is controlled by the desulfurization bacteria culture tank 200, without adding additional reagents to the processing unit 100 for control.

In addition, the aeration device 320 may perform operation O1 and operation O2, and air may be sent to the processing unit 100 and the desulfurization bacteria culture tank 200 (arrows in the drawing can be understood as the flow direction of gas) to provide oxygen for white-rot fungi and desulfurization bacteria. Specifically, the aeration device 320 may inject air into the processing unit 100 and the desulfurization bacteria culture tank 200 through the connection part 302-2 to increase the oxygen content in the processing unit 100 and the desulfurization bacteria culture tank 200.

According to embodiments of the disclosure, by the aforementioned method for processing biological wastewater, the hydraulic retention time of the wastewater W1 containing humic acid or color can be between 10 hours and 27 hours, or between 10 hours and 24 hours. Moreover, the chemical oxygen demand (COD) of the processed wastewater W1′ can be less than 600 ppm, which complies with the discharge water standards for livestock husbandry.

A detailed description is given in the following particular examples in order to provide a thorough understanding of the above and other purposes, features and advantages of the present disclosure. However, the scope of the present disclosure is not intended to be limited to the particular examples.

### Example 1—Water Quality Batch Test Analysis of White-Rot Fungi Immobilized on Porous Carriers

The removal rates of chemical oxygen demand (COD), humic acid and color of white-rot fungi immobilized or not immobilized on the porous carriers were compared. First, the white-rot fungi Panaerochaete chrysosporium was cultured on Potato Dextrose Agar (PDA) in a constant temperature growth chamber at 30° C. for 5 days, and then stored in the refrigerator for later use.

For the group of white-rot fungi immobilized on the porous carriers, 200 mL of sterilized yeast extract peptone dextrose broth (YPD Broth) and the porous carriers were separately dispensed into a 250 mL conical flask. Five fungal colonies of 1 cm×1 cm in size were inoculated on potato dextrose agar (PDA) and shaken at 150 rpm at 30° C. for 5 days. For the group of white-rot fungi not immobilized on the porous carriers, 200 mL of sterilized yeast extract peptone dextrose broth (YPD Broth) was dispensed into a 250 mL conical flask. Five fungal colonies of 1 cm×1 cm in size were inoculated on PDA and shaken at 150 rpm at 30° ° C. for 5 days.

Next, 200 mL of sterilized livestock husbandry wastewater was added to 250 mL serum bottles. The aforementioned porous carriers immobilized with white-rot fungi and the porous carriers without immobilized white-rot fungi were respectively added to the serum bottles containing sterilized livestock husbandry wastewater. The serum bottles were shaken at 150 rpm at 30° C. for 14 days. Samples were taken every two days for analysis of chemical oxygen demand (COD), humic acid, and chromaticity. The results are shown in Table 1 below.

Chemical oxygen demand (COD) was measured according to the standard testing method NIEA W517.53B of the Environmental Protection Administration, Executive Yuan. Humic acid and chromaticity were measured using the spectrophotometric method described by Kavurmaci & Bekbolet (2014). The determination of humic acid was performed by measuring the transmittance at two wavelengths of 254 nm and 365 nm using a spectrophotometer. The determination of chromaticity was performed by measuring the transmittance at a wavelength of 436 nm using a spectrophotometer. The spectrophotometer had a sample cell with a light path of 1 cm×1 cm.

TABLE 1

| | | Day 14 | Day 14 |
|---|---|---|---|
| | | White-rot fungi with- | White-rot fungi with |
| | | out immobilization | immobilization |
| | | (referring to white-rot | (referring to white- |
| Analysis | | fungi not immobilized | rot fungi immobilized |
| item | Day 0 | on the porous carriers) | on the porous carriers) |
| COD | 12,182 | 8,283 | 6,454 |
| (mg/L) | | | |
| E254/ | 1.099 | 1.306 | 1.312 |
| E365(nm) | | | |
| E436(nm) | 1.880 | 0.883 | 0.922 |

| | | |
|---|---|---|
| COD removal rate (%) | 32.0 | 47.0 |
| HA removal rate (%) | 18.8 | 19.4 |
| Color removal rate (%) | 53.0 | 51.0 |

As shown in Table 1, batch test results demonstrate that immobilization of white-rot fungi on the porous carrier can enhance COD removal rate by approximately 15%, achieving a COD removal rate of up to 47%. The removal rates of humic acid and color were only about 19.4% and 51%, respectively, with less significant improvement in their removal rates.

### Example 2—Continuous Water Quality Analysis with Different Microbial Combinations

A continuous reaction tank was used to stabilize the inflow and outflow of wastewater for testing purposes. The removal rates of chemical oxygen demand (COD), humic acid, and color were compared between a combination of white-rot fungi and desulfurization bacteria, activated sludge (obtained from a livestock husbandry wastewater processing system), and white-rot fungi alone. The experiment of the combination of white-rot fungi and desulfurization bacteria was conducted using the structure of the aforementioned biological wastewater processing system 10, while the experiments of activated sludge and white-rot fungi alone were conducted using a single reaction tank. The volume of the single reaction tank was 6 liters, with a hydraulic retention time of 10 hours, and the pH of the inflow water was controlled to pH 5.0˜5.5. Each day, effluent was taken from the processing unit 100 for pH measurement and analysis of chemical oxygen demand (COD), humic acid, and color, and the results are shown in the following Table 2.

TABLE 2

| | White-rot fungi + | Activated | White-rot |
|---|---|---|---|
| Analysis Item | desulfurization bacteria | sludge | fungi |
| Source of H₂SO₄ | Desulfurization bacteria | Additional adding | |
| | culture tank | (50 L of H₂SO₄ (98%)/m³- | |
| | | processed water) | |
| | | H₂SO₄ (98%):800 NT | |
| | | dollars/m³ | |
| Startup time | <2 days | 21 days | <2 days |
| pH value of | 6 | 6 | 6 |
| effluent | | | |
| COD removal | 26.8 | 23.1 | 23.5 |
| rate (%) | | | |
| HA removal rate | 34.7 | 26.4 | 28.3 |
| (%) | | | |
| Color removal | 41.2 | 32.0 | 31.9 |
| rate (%) | | | |

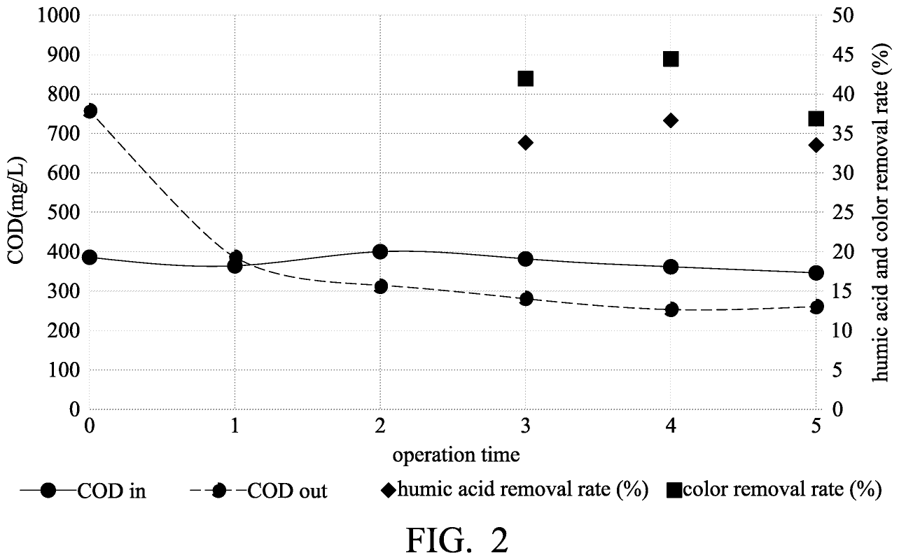

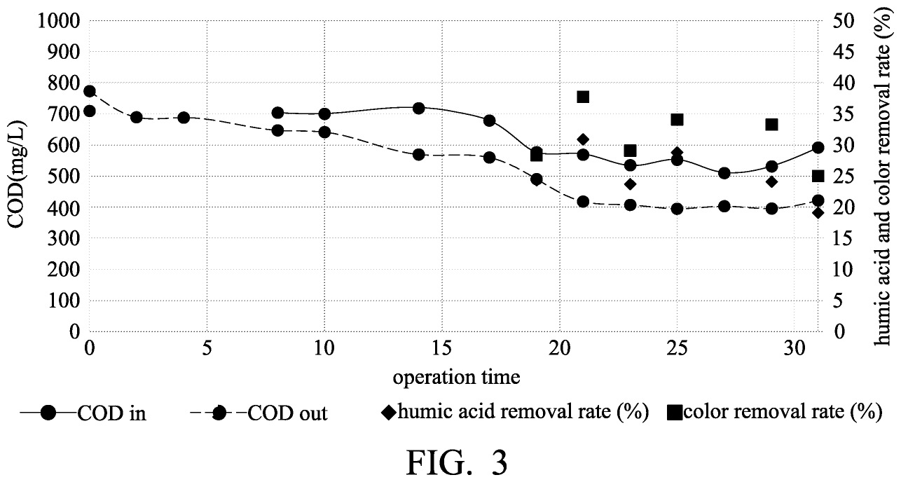

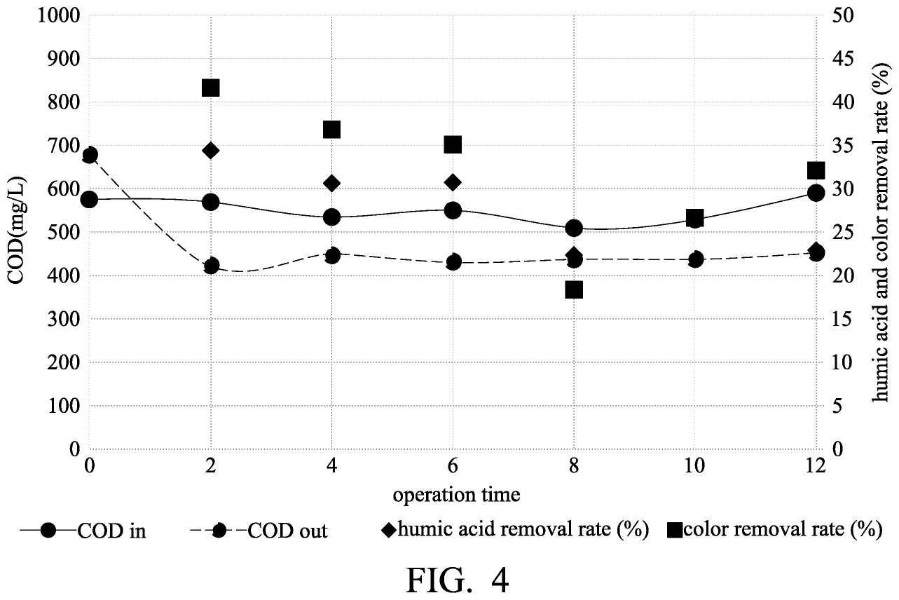

Please refer to Table 2 and FIGS. 2 to 4 (FIG. 2 shows the wastewater processing effect obtained using the biological wastewater processing system shown in FIG. 1; FIG. 3 shows the wastewater processing effect obtained using a continuous reaction tank with activated sludge as the microbial source; FIG. 4 shows the wastewater processing effect obtained using a continuous reaction tank with white-rot fungi as the microbial source). The experimental results show that using white-rot fungi as the microbial source can shorten the system's startup time (startup time refers to the time required to cultivate microorganisms until the effluent can meet the discharge standard, such as a COD removal rate of 20% and a humic acid removal rate of 30%), which can be shortened from 21 days to less than 2 days. Furthermore, the group of white-rot fungi combined with desulfurization bacteria can further improve the COD removal rate to 26.8%, the humic acid removal rate to 34.7%, and the color removal rate to 41.2%, making the effluent meet the discharge standards in the livestock husbandry industry (COD less than 600 mg/L).

In addition, the groups using activated sludge and white-rot fungi alone require the additional addition of sulfuric acid (H₂SO₄) to maintain the system's pH value, increasing the operating costs. In contrast, using the biological wastewater processing system disclosed in the embodiments of the present disclosure does not require additional acid addition to control the pH value, which can reduce operating costs.

To summarize the above, the biological wastewater processing system provided in the present disclosure includes a processing unit with a compound growth of desulfurization bacteria and white-rot fungi, as well as a desulfurization bacteria culture tank. This system can cultivate a large amount of dominant desulfurization bacteria and white-rot fungi, stabilizing the removal of humic acid and color from wastewater, and reducing chemical oxygen demand (COD), thus improving the efficiency of biological wastewater processing. In addition, the liquid produced during the desulfurization reaction in the desulfurization bacteria culture tank can be directly used to adjust the pH value of the processing unit, without adding additional reagents (such as sulfuric acid) for pH control, which can reduce operating costs.

Although some embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods or steps. In addition, each claim constitutes an individual embodiment, and the claimed scope of the present disclosure includes the combinations of the claims and embodiments. The scope of protection of present disclosure is subject to the definition of the scope of the appended claims.

What is claimed is:

1. A biological wastewater processing system, comprising:
a processing unit for removing humic acid or color from wastewater, the processing unit comprising a plurality of porous carriers, wherein desulfurization bacteria and white-rot fungi are immobilized on the plurality of porous carriers; and
a desulfurization bacteria culture tank for cultivating desulfurization bacteria, wherein the desulfurization bacteria culture tank is connected to the processing unit;
wherein the desulfurization bacteria culture tank produces a liquid containing sulfate ions, and the liquid containing sulfate ions is introduced into the processing unit to control the pH value of the processing unit, so that the pH value of the processing unit is between 5.5 and 6.5.

2. The biological wastewater processing system as claimed in claim 1, wherein the ratio of desulfurization bacteria to white-rot fungi is between 1:15 and 1:5.

3. The biological wastewater processing system as claimed in claim 1, wherein the processing unit further comprises a partition plate disposed therein, and the plurality of porous carriers are disposed in a space formed by the partition plate.

4. The biological wastewater processing system as claimed in claim 3, wherein the partition plate has a plurality of holes whose size is smaller than the size of the porous carriers.

5. The biological wastewater processing system as claimed in claim 1, further comprising an aeration device, wherein the aeration device is connected to the bottom of the processing unit and the bottom of the desulfurization bacteria culture tank through a connection part.

6. The biological wastewater processing system as claimed in claim 1, further comprising a first inlet for introducing the wastewater containing humic acid or color into the processing unit, wherein the first inlet is disposed at the bottom of the processing unit.

7. The biological wastewater processing system as claimed in claim 1, further comprising a second inlet for introducing a wastewater containing sulfur into the desulfurization bacteria culture tank, wherein the second inlet is disposed at the bottom of the desulfurization bacteria culture tank.

8. The biological wastewater processing system as claimed in claim 1, further comprising an outlet for exporting the processed wastewater out of the processing unit, wherein the outlet is disposed at the top of the processing unit.

9. The biological wastewater processing system as claimed in claim 1, wherein the pH value of the desulfurization bacteria culture tank is between 1 and 4.

10. The biological wastewater processing system as claimed in claim 1, wherein the filling rate of the plurality of porous carriers in the processing unit is between 60% and 90%.

11. The biological wastewater processing system as claimed in claim 1, wherein the pore size of the plurality of porous carriers is between 200 micrometers and 2000 micrometers.

12. The biological wastewater processing system as claimed in claim 1, wherein the specific surface area of the plurality of porous carriers is between 800 m²/m³ and 8000 m²/m³.

13. A method for processing biological wastewater, comprising:
providing a biological wastewater processing system comprising:
a processing unit for removing humic acid or color from wastewater, the processing unit comprising a plurality of porous carriers, wherein desulfurization bacteria and white-rot fungi are immobilized on the plurality of porous carriers; and
a desulfurization bacteria culture tank for cultivating desulfurization bacteria, wherein the desulfurization bacteria culture tank is connected to the processing unit;
wherein the desulfurization bacteria culture tank produces a liquid containing sulfate ions, and the liquid containing sulfate ions is introduced into the processing unit to control the pH value of the processing unit, so that the pH value of the processing unit is between 5.5 and 6.5;
introducing a wastewater containing humic acid or color into the biological wastewater processing system; and
exporting the processed wastewater out of the processing unit.

14. The method for processing biological wastewater as claimed in claim 13, wherein the pH value of the desulfurization bacteria culture tank is between 1 and 4.

15. The method for processing biological wastewater as claimed in claim 13, wherein the biological wastewater processing system further comprises a first inlet for introducing the wastewater containing humic acid or color into the processing unit, and the first inlet is disposed at the bottom of the processing unit.

16. The method for processing biological wastewater as claimed in claim 13, wherein the biological wastewater processing system further comprises a second inlet for introducing a wastewater containing sulfur into the desulfurization bacteria culture tank, and the second inlet is disposed at the bottom of the desulfurization bacteria culture tank.

17. The method for processing biological wastewater as claimed in claim 13, wherein the biological wastewater processing system further comprises an aeration device connected to the processing unit and the desulfurization bacteria culture tank, and the aeration device sends air to the processing unit and the desulfurization bacteria culture tank to provide oxygen for desulfurization bacteria and white-rot fungi.

18. The method for processing biological wastewater as claimed in claim 13, wherein the pH value of the processing unit is controlled by the desulfurization bacteria culture tank.

19. The method for processing biological wastewater as claimed in claim 13, wherein the wastewater containing humic acid or color comprises livestock husbandry wastewater, agricultural wastewater, wastewater from biomass energy plants, industrial wastewater, or a combination thereof, and the chemical oxygen demand (COD) of the processed wastewater is less than 600 ppm.

20. The method for processing biological wastewater as claimed in claim 13, wherein the hydraulic retention time of the wastewater containing humic acid or color is between 10 hours and 27 hours.
